(19) United States
(12) Patent Application Publication
(10) Pub. No.: US 2006/0059738 A1
(43) Pub. Date: Mar. 23, 2006

(54) Rocking head picture display device

(76) Inventor: Chien-Hsun Tsao, Sinjhuang City (TW)

Correspondence Address: HDSL, 4331 STEVENS BATTLE LANE, FAIRFAX, VA, 22033, US

(21) Appl. No.: 11/178,357

(22) Filed: Jul. 12, 2005

(30) Foreign Application Priority Data
Jul. 14, 2004 (TW) 093211060

(51) Int. Cl. G09F 19/08

(52) U.S. Cl. 40/414

(57) ABSTRACT

A rocking head picture display device includes a stand, a body picture and a head picture. The stand has a rocking member extending from the top. The body picture is mounted on a front surface of the stand. The head picture is mounted on the extended rocking member so that the head picture is rocking with respect to the body picture. Accordingly, users can conveniently arrange a photo onto a rocking machine to make living and funny personal photo display.

### BACKGROUND OF THE INVENTION

1. Field of Invention

The present invention relates in general to a picture display device, and more particularly, to a rocking head picture display device for users to conveniently arrange a photo onto a rocking machine to make living and funny personal photo display.

2. Related Art

Taking pictures are wonderful experience in daily life and during a journey. Traditionally, people use picture frames to display their lovely photos. Nowadays, through the Internet, digital photos can be posted to a web page for distant viewing. However, it still seems not enough to just statically show pictures in these ways because of lacking fun. Life is bored. If we can change something we get used to in different presentation, our life may be filled and full with varieties and amusement. Photo display is exactly one of the examples.

### SUMMARY OF THE INVENTION

Accordingly, the present invention is to provide a rocking head picture display device for users to conveniently arrange a photo onto a rocking machine to make living and funny personal photo display.

The rocking head picture display device of the present invention includes a stand, a body picture and a head picture. The stand has a rocking member extending from the top. The body picture is mounted on a front surface of the stand. The head picture is mounted on the extended rocking member so that the head picture is rocking with respect to the body picture.

### BRIEF DESCRIPTION OF THE DRAWINGS

The present invention will become more fully understood from the detailed description given hereinbelow illustration only, and thus are not limitative of the present invention, and wherein:

FIG. 1 shows a perspective view of a rocking machine according to the present invention;

FIG. 2 shows an exploded view of a rocking head picture display device according to the present invention;

FIG. 3 shows a perspective view of a rocking head picture display device according to the present invention; and

FIG. 4 shows a rocking head picture display device of the present invention in application.

### DETAILED DESCRIPTION OF THE INVENTION

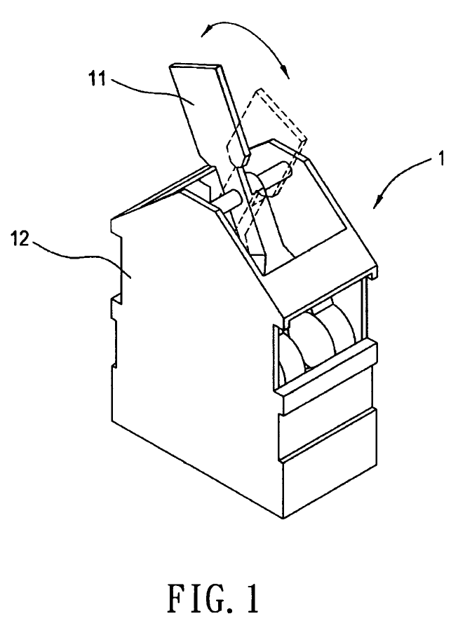

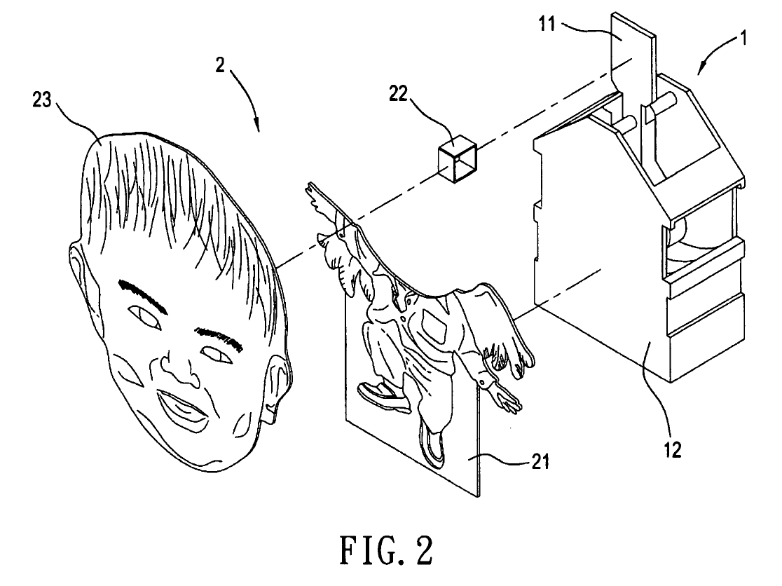

Referring to FIGS. 1 and 2, a rocking head picture display of present invention includes a rocking machine 1 and a picture 2. The rocking machine 1 includes a stand and a rocking member 11 extending from the top of the stand. The rocking member 11 can be powered by a battery or use solar power to swing back and forth. The picture 2 includes two parts of a body picture 21 and a head picture 23. The body picture 21 is mounted on a front surface 12 of the stand. The head picture 23 is mounted on the extended end of the rocking member 11. A connector 22, such as in form of a cubic frame, can be used to connect between the head picture 23 and the rocking member 11. As such, the body picture 21 and the head picture 23 are parallel located at different planes, and preferably the head picture 23 is located in front of the body picture 21. Moreover, the head picture 23 is preferably larger than the body picture 21. The body picture 21 and the head picture 23 can be made from a person photo or a pet photo; therefore, a personal living and funny photo display is presented. In other case, the body picture 21 can be a cartoon character body picture plate and integrally formed as a front plate of the stand or detachably mounted to the stand. Therefore, different body picture 21 can be chosen to match the head picture 23 to provide more entertainment.

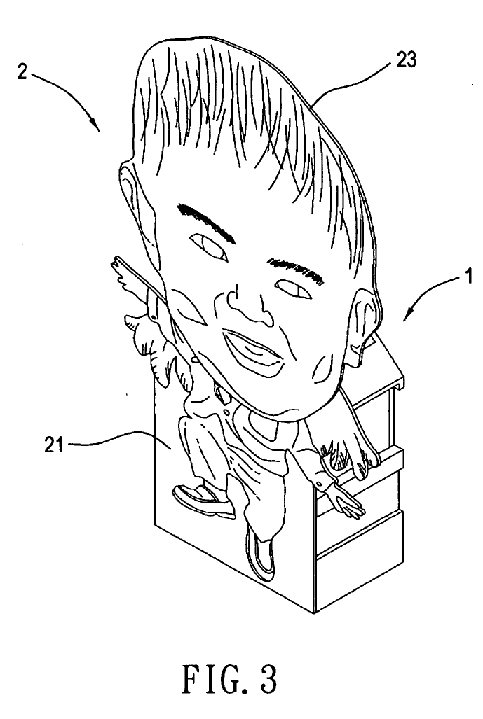

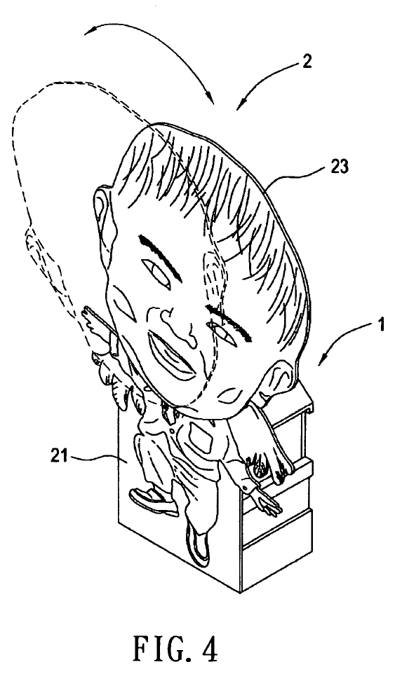

As shown in FIGS. 3 and 4, when the rocking machine 1 is powered on, the rocking member 11 will begin to swing back and forth. That is, the head picture 23 will swing back and forth in front of the body picture 21 to show a character with a rocking head. If a baby or an adult photo is used, the device will be like a rocking head doll. Otherwise, if a pet photo is used, another kind of cute presentation is shown.

The present invention has the advantages as follows.
(1) Through the use of the connector, the head picture is rocking in front of the body picture; therefore, a living and cute picture display can be obtained.
(2) The head picture is larger than the body picture in proportion; therefore a cartoon effect of picture display can be obtained.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rocking head picture display device comprising:
a stand having a rocking member extending from the top;
a body picture mounted on a front surface of the stand; and
a head picture mounted on the extended rocking member so that the head picture is rocking with respect to the body picture.

2. The device of claim 1, wherein the rocking member is powered by a battery.

3. The device of claim 1, wherein the rocking member is powered by a solar power.

4. The device of claim 1, wherein the body picture is a cartoon character body picture plate.

5. The device of claim 4, wherein the head picture is a head photo of a person and is larger than the body picture in proportion.

6. The device of claim 4, wherein the body picture is detachably mounted on the stand so that a plurality of body pictures can be respectively changed to match with the stand.

7. The device of claim 4, wherein the body picture is integrally formed as a front plate of the stand.

8. The device of claim 1, wherein the body picture and the head picture are from a person photo.

9. The device of claim 1, wherein the body picture and the head picture are from a pet photo.

10. The device of claim 1, wherein the body picture and the head picture are parallel located at different planes.

11. The device of claim 1, wherein the head picture is located in front of the body picture.

12. The device of claim 1, further comprising a connector for connecting the head picture to the rocking member.

13. The device of claim 1, wherein the connector is a cubic frame.
